(19) United States
(12) Patent Application Publication
(10) Pub. No.: US 2022/0148465 A1
(43) Pub. Date: May 12, 2022

(54) Placard Clip

(71) Applicant: American Labelmark Company, Chicago, IL (US)

(72) Inventors: Michael J. Kaufman, Morton Grove, IL (US); Kimberley A. Shikami, Glenview, IL (US)

(21) Appl. No.: 17/092,009

(22) Filed: Nov. 6, 2020

(51) Int. Cl. G09F 15/00

(52) U.S. Cl. CPC G09F 15/0018

(57) ABSTRACT

A placard clip comprises a base having a first base end and first and second base portions extending from the first base end toward a second base end along a first direction. The first base portion has a first lip and the second base portion has a second lip, and the first lip and the second lip extend in opposite directions transverse to the first direction and define a recess therebetween. The placard clip further comprises a latch having a first latch portion disposed at a first latch end wherein the first latch portion is disposed in the recess and wherein the latch includes a second latch portion disposed at a second latch end opposite the first latch end.

### FIELD OF DISCLOSURE

The present subject matter relates to a clip, and more particularly to a clip for securing a placard to a side or other surface of a vehicle.

### BACKGROUND

A placard having indicia thereon may be secured to a container used to carry or move different products. Such container may be one of an intermediate bulk container, a trailer, railcar, truck, tank (rail or storage), or other vehicle body, a building, or other movable or stationary item. The indicia on the placard may be a sequence of characters specified by a regulatory organization (e.g., the U.S. Department of Transportation, the International Maritime Organization, and the like), that identifies the contents of the container and whether special care needs to be taken during transport or storage of such contents.

Preprinted panels having particular indicia imprinted thereon associated with particular materials and placard frames that hold such panels are commercially available. The placard frame is secured to a container and a preprinted placard is removably inserted or secured to the placard frame to identify the contents of the container. For example, when the container is used to hold first contents, a first preprinted placard associated with the first contents is selected from a plurality of preprinted placards and inserted into the frame. Thereafter, when the container is used to hold second contents, the first preprinted placard is removed from the placard frame and a second preprinted placard associated with the second contents is selected from the plurality of preprinted placards and inserted into the frame.

As seen in FIG. 1, such a placard 20 disposed in a placard frame 22. A prior art placard clip 24 is typically associated with the placard frame 22, is secured thereto by suitable fasteners 25a, 25b, and is movable between closed and open positions to allow the placard 20 to be changed as required and secured in place within the frame 22 such that indicia 26 are visible for outside the frame 22. An integral member 27 aids in insertion and removal of the placard 20.

Referring also to FIGS. 1A and 2, the prior art placard clip 24 typically comprises a base 32 and a latch 34 separate from the base 32 and assembled therewith. During assembly. a T-shaped head portion 36 of the latch 34 is inserted into a recess 38 defined by spaced arm portions 40, 42 of the base 32 and a planar central portion 44 of the base 32. The arm portions 40, 42 are resiliently flexible and the central portion 44 can resiliently deflect at a weakened line 46 relative to a balance 48 of the base 32 to permit the arm portions 40, 42 to be moved away from the central portion 44 so that assembly of the latch 34 to the base 32 is facilitated. After assembly, the arm portions 40, 42 and the central portion spring back to their undeflected positions (or nearly so) to capture the head portion 36 in the recess 38.

It has been found that the design of the prior art clip 24 can be problematic because there exists a possibility of removal of the head portion 36 from the recess 38, and thus the latch 34 may be unintentionally removed from the base 32. This can occur when there is separation between one or both of the arm portions 40, 42 and the central portion 44 and a force is applied to the latch 34. Also, this problem may arise more frequently when the resiliency of the arm portions 40, 42 and the central portion 44 lessens after some period of use.

### SUMMARY

According to one aspect, a placard clip comprises a base having a first base end and first and second base portions extending from the first base end toward a second base end along a first direction. The first base portion has a first lip and the second base portion has a second lip, and the first lip and the second lip extend in opposite directions transverse to the first direction and define a recess therebetween. The placard clip further comprises a latch having a first latch portion disposed at a first latch end wherein the first latch portion is disposed in the recess and wherein the latch includes a second latch portion disposed at a second latch end opposite the first latch end.

According to another aspect a placard clip comprises a base having a first base end and a pair of spaced outer base portions extending from the first base end toward a second base end along a first direction. The base further has a central base portion disposed between the pair of spaced outer base portions and extending along the first direction, wherein each of the pair of spaced outer base portions includes an outboard lip and the central base portion has a central lip, respectively. The outboard lips and the central lip extend in opposite directions transverse to the first direction and define a recess therebetween. A latch having a first latch portion is disposed at a first latch end wherein the first latch portion is disposed in the recess and the latch includes a second latch portion disposed at a second latch end opposite the first latch end.

Other aspects and advantages will become apparent upon consideration of the following detailed description and the attached drawings wherein like numerals designate like structures throughout the specification.

### BRIEF DESCRIPTION OF THE DRAWINGS

FIG. 1 is an isometric view of a placard frame incorporating a placard clip;

FIG. 1A is an isometric view from below of a prior art placard clip;

FIG. 2 is a side elevational view of the prior art placard clip of FIG. 1A;

FIG. 3 is an isometric view from below and from one side of a placard clip according to a first embodiment;

FIG. 4 is an isometric view from above and from the one side of the placard clip of FIG. 3;

FIG. 5 is a side view of the placard clip of FIG. 3 shown in a closed position;

FIG. 5A is a sectional fragmentary view of the placard clip of FIG. 3 taken generally along the lines 5A-5A of FIG. 4 shown in an open position;

FIG. 6 is an isometric view from above and from another side of the base of the placard clip of FIG. 3;

FIG. 7 is an isometric view from above and from the other side of the latch of the placard clip of FIG. 3;

FIG. 8 is an isometric view from below and from the one side of a placard clip according to a second embodiment; and

FIG. 9 is an isometric view from below and from one side of a placard clip according to a third embodiment.

### DETAILED DESCRIPTION

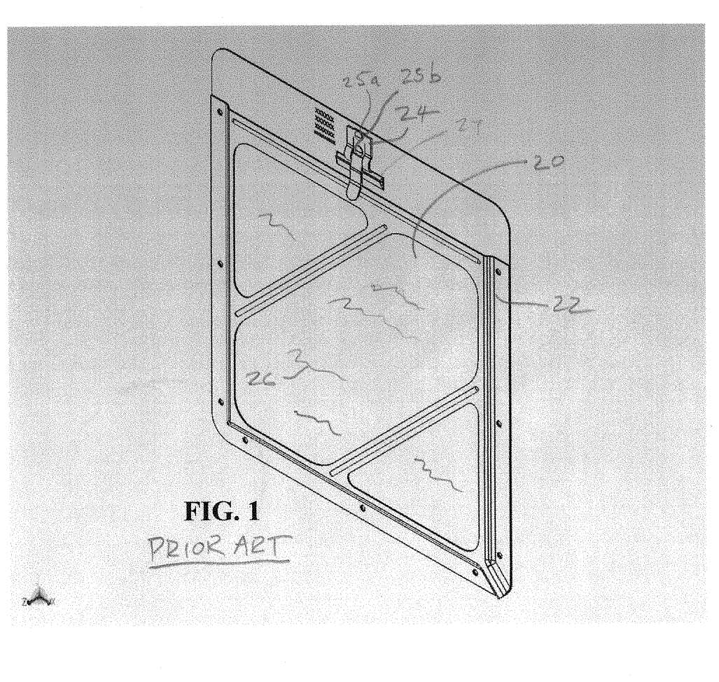

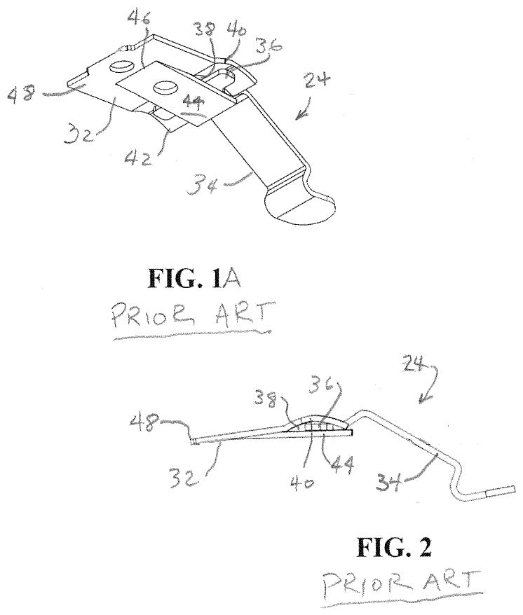

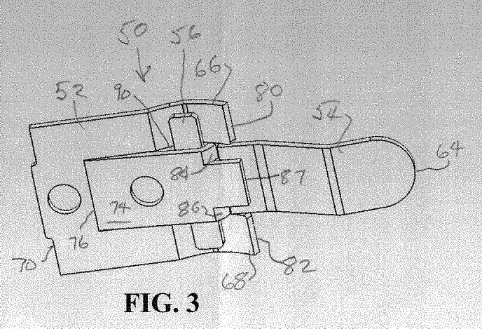

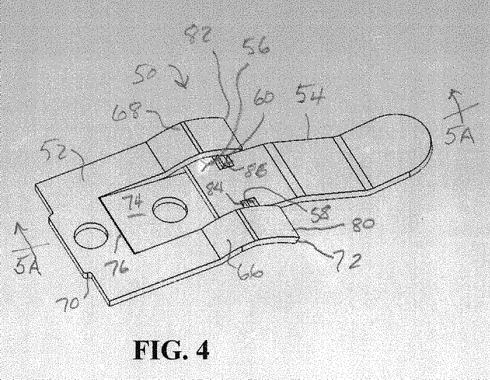

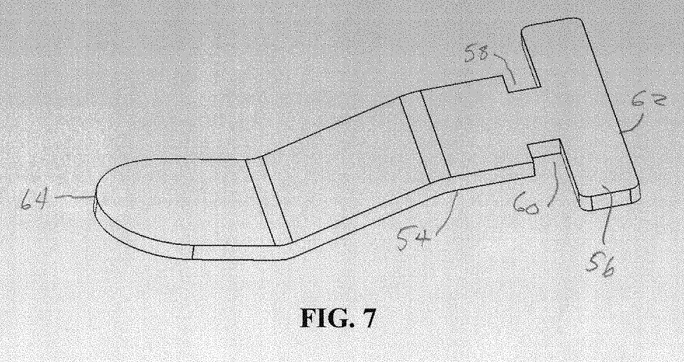

FIGS. 3-7 show a first embodiment of a placard clip 50 that may be used in place of the clip 24. It may be noted that more than one clip 50 may be used with the frame 20 or at least one such clip 50 may be used with any other suitable structure. The placard clip 50 comprises one or more structures that permit assembly but minimize the chance that parts might be unintentionally disassembled. The placard clip may be secured to the placard frame 22 by suitable fasteners (visible as elements 25a, 25b in FIG. 1 but nor shown in the remaining FIGS.).

The clip 50 includes a base 52 and a latch 54 separate from the base 52 and assembled therewith. The base 52 and/or the latch 54 may be of any suitable design, such as the design(s) shown in the FIGS. In the illustrated embodiment, the latch 54 includes a T-shaped head portion 56 and at least one, and more preferably a pair of spaced side recesses 58, 60 disposed at side locations intermediate first and second ends 62, 64, respectively, of the latch 54. Also in the illustrated embodiment, the recesses 58, 60 are disposed at substantially equal distances between from the first end 62 and are further disposed adjacent the T-shaped head portion 56, although this need not necessarily be the case.

The base 52 includes at least one, and more preferably a pair of spaced outer base portions 66, 68 extending from a first base end 70 toward a second base end 72 along a first or longitudinal direction. The base 52 further includes at least one central base portion 74 disposed between the pair of spaced outer base portions 66, 68 and extending along the first direction from a weakened line 76. Each of the pair of spaced outer base portions 66, 68 includes an outboard lip 80, 82, respectively. In the illustrated embodiment, the central base portion includes at least one or more, and, more preferably, a pair of spaced inboard side lips 84, 86 disposed at or adjacent a terminal end 87 of the central base portion 74, adjacent the outboard lips 80, 82, respectively. Preferably, although not necessarily, there is a one-to-one correspondence of inboard side lips 84, 86 and the side recesses 58, 60. The outboard lips 80, 82 and the inboard side lips 84, 86 extend generally toward one another in opposite directions transverse to the first direction and define a recess 90 therebetween.

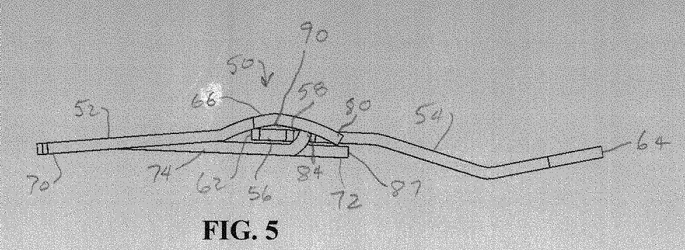

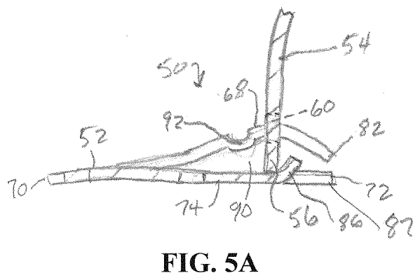

Still further in the illustrated embodiment, the side lips 84, 86 extend into the side recesses 58, 60 when the T-shaped head portion 56 is inserted into the recess 90 when the latch 54 is assembled with the base 52. The lips 84, 86 preferably have a shape or shapes (such as curved or piecewise linear) and the side recesses 58, 60 are of a size to permit movement of the lips 84, 86 into and out of the side recesses 58, 60 as the latch 54 is moved between a closed position (seen in FIGS. 4 and 5) and an open position (FIG. 5A).

As can be seen in FIGS. 5 and 5A, regardless of the position of the latch 54, the lips 84, 86 are of a size and shape to minimize the possibility of unintentional removal of the latch 54 from the base 52 due to interference of the T-shaped head portion 56 with the lips 84, 86. In the illustrated embodiment this interference is accomplished by ensuring that there is no vertical gap between the lips 84, 86 and portions of the latch 54 defining the side recesses 58, 60, although some gap may be tolerated without adversely affecting the trapping function, for example, a gap at or less than the thickness of the latch 54.

As shown in FIG. 5A, an optional inwardly projecting member 92 may be formed in the material of one or both outer base portions 66, 68 that forms a stop to limit movement of the latch 54 in the recess 90 beyond a particular rearward position.

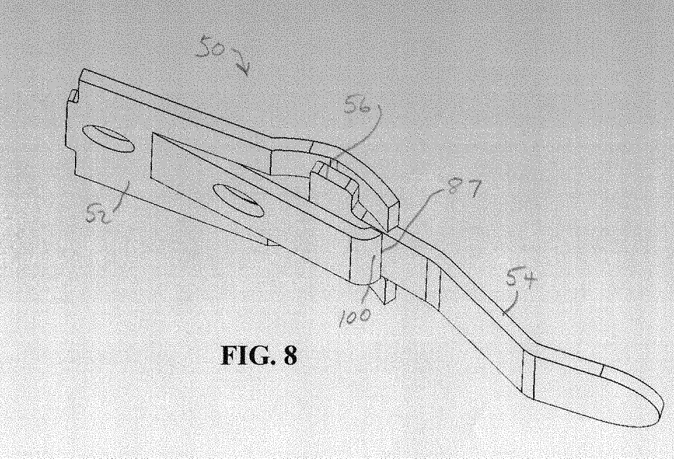

FIG. 8 illustrates an alternative embodiment in which the at least one of the lips 84, 86 may be replaced by a single lip 100 that extends substantially fully or partially across the terminal end 87. Also in such embodiment, the side recesses 58, 60 may be omitted. As in the previous embodiment, interference between the T-shaped head portion 56 and the lip 100 minimizes the possibility of unintended removal of the latch 54 from the base 52.

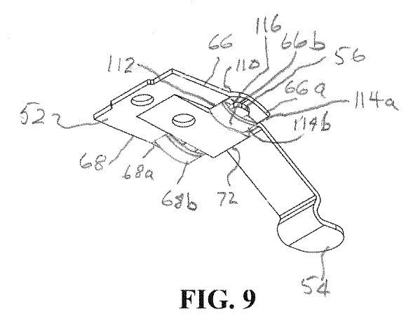

FIG. 9 illustrates yet another embodiment in which each of the outer base portions 66, 68 terminates at a pair of opposed lips 66a, 66b and 68a, 68b, respectively. The pair of opposed lips 66a, 66b is identical to the pair of opposed lips 68a, 68b, and hence, only the pair of lips 66a, 66b will be described herein. The opposed lips 66a, 66b, are integral with the remainder of the outer base portion 66 at ends 110, 112 and separately extend in side-by-side relationship toward the second base end 72. The opposed lips 66a, 66b extend in opposite directions in the height direction upwardly and downwardly (as seen in FIG. 9) and terminate at lip ends 114a. 114b, respectively, that are disposed at substantially the same height or slightly overlap. Further, the opposed lips 66a, 66b are resiliently flexible so that one end of the T-shaped head portion 56 may be inserted into and retained within a recess 116 that is defined between the opposed lips 66a, 66b. Preferably, although not necessarily, the opposed lips 66a, 66b are symmetric with respect to one another about the plane of the T-shaped head portion 56. Also in the illustrated embodiment of FIG. 9, the side recesses 58, 60 of the T-shaped head portion 56 may be omitted. The other end of the T-shaped head portion 56 may be similarly inserted into the pair of opposed lips 68a, 68b to retain the latch 54 with the base 52. As in the previous embodiments, interference between the T-shaped head portion 56 and the lips 66a, 66b and 68a, 68b minimizes the possibility of unintended removal of the latch 54 from the base 52.

### INDUSTRIAL APPLICABILITY

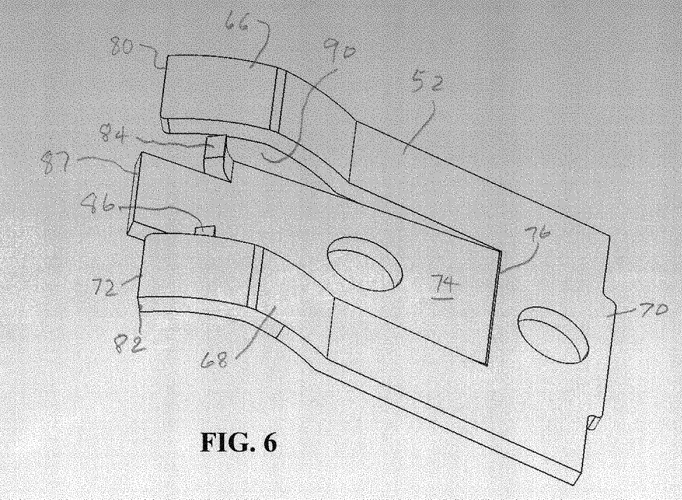

It may be noted that the base 52 may include a greater or lesser number of outer base portions and a greater or lesser number of central base portions, a greater or lesser number of inboard and/or outboard lips, etc. Also, as illustrated by a comparison of FIGS. 6 and 8, one or more of the lips 66a, 66b, 68a, 68b, 84, 86 may terminate at a longitudinal position short of (i.e., longitudinally offset with respect to) the longitudinal termination position of one or more of the lips 66a, 66b, 68a, 68b, 84, 86 (as seen in FIG. 6) and/or may terminate at substantially the same longitudinal position opposite one another (FIG. 8). Also, some or all of the lips 66a, 66b, 68a, 68b, 80, 82, 84, and/or 86 may be disposed at the terminal ends of the outer base portions and/or the at least one central base portion or some or all of same may be disposed at other than terminal ends.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar references in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Numerous modifications to the present disclosure will be apparent to those skilled in the art in view of the foregoing description. It should be understood that the illustrated embodiments are exemplary only, and should not be taken as limiting the scope of the disclosure.

We claim:

1. A placard clip, comprising:
a base having a first base end and first and second base portions extending from the first base end toward a second base end along a first direction, wherein the first base portion has a first lip and the second base portion has a second lip, and wherein the first lip and the second lip extend in opposite directions transverse to the first direction and define a recess therebetween; and
a latch having a first latch portion disposed at a first latch end wherein the first latch portion is disposed in the recess and wherein the latch includes a second latch portion disposed at a second latch end opposite the first latch end.

2. The placard clip of claim 1, wherein the first base portion terminates at the first lip.

3. The placard clip of claim 2, wherein the second base portion terminates at the second lip.

4. The placard clip of claim 1, wherein the first lip and the second lip are disposed substantially at equal distances along the first direction.

5. The placard clip of claim 1, wherein the first lip and the second lip are disposed at offset positions along the first direction.

6. The placard clip of claim 1, wherein the first lip comprises a single curved member.

7. The placard clip of claim 1, wherein the first lip comprises two spaced members each of which is one of a curved shape and a piecewise linear shape.

8. The placard clip of claim 7, wherein the latch further includes a third latch portion disposed between the first latch end and the second latch end.

9. The placard clip of claim 8, wherein the third latch portion comprises a pair of recesses that receive the two spaced members.

10. The placard clip of claim 1, wherein the second base portion includes an inwardly projecting member disposed between the first base end and the second lip.

11. The placard clip of claim 1 wherein the first base portion comprises a central base portion and the second base portion comprises an outer base portion.

12. The placard clip of claim 1, wherein the first base portion and the second base portion together comprise an outer base portion disposed adjacent a central base portion.

13. A placard clip, comprising:
a base having a first base end and a pair of spaced outer base portions extending from the first base end toward a second base end along a first direction and further having a central base portion disposed between the pair of spaced outer base portions and extending along the first direction, wherein each of the pair of spaced outer base portions includes an outboard lip and the central base portion has at least one inboard side lip, respectively, and wherein the outboard lips and the at least one inboard side lip extend in opposite directions transverse to the first direction and define a recess therebetween; and
a latch having a first latch portion disposed at a first latch end wherein the first latch portion is disposed in the recess and wherein the latch includes a second latch portion disposed at a second latch end opposite the first latch end.

14. The placard clip of claim 13, wherein the at least one inboard side lip and the outboard side lips are disposed substantially opposite one another along the first direction.

15. The placard clip of claim 13, wherein the at least one inboard side lip and the outboard side lips are disposed at offset positions along the first direction.

16. The placard clip of claim 13, wherein the at least one inboard side lip comprises a single curved member.

17. The placard clip of claim 13, wherein the at least one inboard side lip comprises two spaced members, each of which is one of a curved shape and a piecewise linear shape.

18. The placard clip of claim 17, wherein the latch further includes a third latch portion disposed between the first latch end and the second latch end.

19. The placard clip of claim 18, wherein the third latch portion comprises a pair of recesses that receive the two spaced members.

20. The placard clip of claim 13, wherein at least one of the pair of spaced outer base portions includes an inwardly projecting member disposed between the first base end and the second base end.
